(19) United States
(12) Patent Application Publication
(10) Pub. No.: US 2026/0027558 A1
(43) Pub. Date: Jan. 29, 2026

(54) PHOTOCATALYST COMPOSITE, METHOD OF PREPARING THE SAME AND METHOD OF PRODUCING HYDROGEN

(71) Applicant: National Cheng Kung University, Tainan (TW)

(72) Inventors: YI-HSUAN LAI, Tainan (TW); PEI-WEN YEH, Tainan (TW); MENG-JYUN JHONG, Tainan (TW); PING-CHANG CHUANG, Tainan (TW); NING-HUI YANG, Tainan (TW)

(21) Appl. No.: 18/890,964

(22) Filed: Sep. 20, 2024

(30) Foreign Application Priority Data
Jul. 26, 2024 (TW) 113127929

(51) Int. Cl. B01J 27/24; B01J 23/745; B01J 35/39; B01J 37/00; B01J 37/04; B01J 37/08; B01J 37/34; C01B 3/32; C01B 21/06; C01G 49/00

(52) U.S. Cl. CPC B01J 27/24; B01J 23/745; B01J 35/39; B01J 37/0036; B01J 37/04; B01J 37/08; B01J 37/343; C01B 3/326; C01B 21/0605; C01G 49/0018; C01B 2203/0227; C01B 2203/1047; C01B 2203/1211

(57) ABSTRACT

The present invention provides a photocatalyst composite, a method of preparing the same, and a method of producing hydrogen. The method of preparing the photocatalyst composite includes a step of preparing g-C₃N₄, a step of preparing CuFeO₂ and a step of synthesizing g-C₃N₄/CuFeO₂. Preparing g-C₃N₄ includes heating a predetermined weight of melamine at a predetermined heating rate for a predetermined time to obtain g-C₃N₄ powder. Preparing CuFeO₂ includes hydrothermal synthesis followed by drying to obtain CuFeO₂ powder. Synthesizing g-C₃N₄/CuFeO₂ includes mixing the g-C₃N₄ powder and the CuFeO₂ powder obtained in the previous steps with a predetermined ratio to obtain a photocatalyst composite of g-C₃N₄/CuFeO₂ in which the photocatalyst composite has a heterogeneous structure. The method of producing hydrogen includes adding plastic to an alkaline solution to form a pretreatment solution and performing hydrogen production through a photoreforming reaction in the plastic pretreatment solution using the aforementioned photocatalyst composite.

### CROSS-REFERENCE TO RELATED APPLICATIONS

This application claims priority to Taiwan Application Serial Number 113127929, filed Jul. 26, 2024, which is herein incorporated by reference in its entirety.

### BACKGROUND

### Technical Field

The present invention relates to a photocatalyst composite and a method of preparing the same, particularly to a method of producing hydrogen using the photocatalyst composite.

### Related Art

In order to solve issues of pollution caused by plastic waste and energy shortage, there is a method of photoreforming plastics in the prior art, which uses hydrolyzed plastic as a raw material to generate hydrogen under sunlight irradiation with the help of a suitable photocatalyst. On the other hand, the hydrolyzed plastic is degraded into economically valuable chemicals. That is, if the waste plastic is used as a reactant, not only green hydrogen can be produced, but valuable chemicals can also be produced at the same time.

However, in the existing methods of photoreforming plastics, most of the photocatalysts are highly toxic (e.g., cadmium sulfide), or a precious metal material (e.g., platinum) needs to be used as a co-catalyst, which is detrimental to the sustainability of this technology.

Therefore, how to provide a photocatalyst with low toxicity or even non-toxicity and low cost is an issue worthy of consideration in the industry.

### SUMMARY

In view of the above, the invention in the present disclosure proposes a simple and low-cost method to prepare a photocatalyst composite composed of non-toxic and earth-abundant elements. The photocatalyst composite (herein represented as photocatalyst I/photocatalyst II) is composed of an n-type semiconductor (photocatalyst I) and a p-type semiconductor (photocatalyst II). In particular, photocatalyst I/photocatalyst II (hereinafter referred to as the “photocatalyst composite”) can perform photocatalysis to produce hydrogen in an alkaline environment containing polyester plastics, and its effect is far better than using photocatalyst I or photocatalyst II alone. Additionally, in the invention disclosed in the present disclosure, formic acid is the primary oxidized organic product. Furthermore, in the invention disclosed in the present disclosure, tap water, ditch water, and seawater are used as alternative water sources, and photocatalyst I/photocatalyst II also has good hydrogen production activity in an environment containing hydrolyzed polyester microfibers. That is, in an alkaline hydrolyzed plastic solution, the photocatalyst can produce hydrogen under light irradiation. Therefore, the invention disclosed in the present disclosure has potential application value in both plastic waste treatment and energy production. In summary, the photocatalyst composite composed of photocatalyst I and photocatalyst II in the invention disclosed in the present disclosure is suitable for photocatalytic hydrogen production and photoreforming plastics for hydrogen production, especially in alkaline environments containing polyester plastics, with good hydrogen production efficiency.

One aspect of the present disclosure provides a photocatalyst composite. The material of the photocatalyst composite is g-C₃N₄/CuFeO₂, which has a heterogeneous structure and does not have additional crystalline impurities.

According to one or more embodiments of the present disclosure, g-C₃N₄ and CuFeO₂ used to form the photocatalyst composite are powders, and the weight ratios are 1:1 to 7:1, and an optimal weight ratio is 5:1.

Another aspect of the present disclosure provides a method of preparing a photocatalyst composite, which includes a step of preparing g-C₃N₄, a step of preparing CuFeO₂, and a step of synthesizing g-C₃N₄/CuFeO₂. Preparing g-C₃N₄ includes heating a predetermined weight of melamine at a predetermined heating rate for a predetermined time. Preparing CuFeO₂ includes using hydrothermal synthesis followed by drying. Synthesizing g-C₃N₄/CuFeO₂ includes mixing the g-C₃N₄ powder and the CuFeO₂ powder obtained in the previous steps with a predetermined ratio, in which the photocatalyst composite has a heterogeneous structure.

According to one or more embodiments of the present disclosure, in the step of preparing g-C₃N₄, 2 g of melamine is placed in an Al₂O₃ crucible, followed by being covered with a crucible lid and then heated at a rate of 2° C./min to 550° C. and maintained for 4 hours.

According to one or more embodiments of the present disclosure, in the step of preparing CuFeO₂, a predetermined amount of CuSO₄·5H₂O, a predetermined amount of FeSO₄·7H₂O and a predetermined amount of NaOH are dissolved in a predetermined amount of H₂O to prepare a precursor solution. A predetermined amount of the precursor solution is then placed into an autoclave and kept at a predetermined temperature for a predetermined time. A black powder is obtained by centrifugation followed by repeated washing with a mixed solution of ethanol and water. The black powder is dispersed in water and dried at a predetermined temperature to obtain the CuFeO₂ powder.

According to one or more embodiments of the present disclosure, in the step of preparing CuFeO₂, 7.5 mmol of CuSO₄·5H₂O, 7.5 mmol of FeSO₄·7H₂O and 110 mmol of NaOH are dissolved in 35 ml of H₂O to prepare a precursor solution. 16 ml of the precursor solution is then placed into a 23 ml autoclave and kept at 160° C. for 6 hours. A black powder is obtained by centrifugation followed by repeated washing with a mixed solution of ethanol and water. The black powder is dispersed in water and dried at 60° C. to obtain the CuFeO₂ powder.

According to one or more embodiments of the present disclosure, in the step of synthesizing g-C₃N₄/CuFeO₂, the g-C₃N₄ powder and the CuFeO₂ powder obtained in the previous steps are mixed in a specific weight ratio to obtain the photocatalyst composite.

According to one or more embodiments of the present disclosure, in the step of synthesizing g-C₃N₄/CuFeO₂, the g-C₃N₄ powder and the CuFeO₂ powder obtained in the previous steps are mixed in a weight ratio of 1:1, 3:1, 5:1 or 7:1 to obtain the photocatalyst composite, in which an optimal ratio is 5:1; g-C₃N₄ and CuFeO₂ are dispersed in an ethanol-water mixed solution with a volume ratio of 1:1 followed by sonicating for 30 minutes and then keeping stirred at 80° C. until a solvent completely evaporates. The mixture is then heated at no more than 300° C. for 2 hours in a tube furnace under N₂ atmosphere to obtain the photocatalyst composite, in which an optimal temperature is 300° C.

A further aspect of the present disclosure provides a method of producing hydrogen, which includes adding a plastic to an alkaline solution to form a pretreatment solution and performing photoreforming plastics for hydrogen production in the pretreatment solution using the aforementioned photocatalyst composite.

According to one or more embodiments of the present disclosure, in the step of forming the pretreatment solution, the plastic is added to a KOH solution with a predetermined volume molar concentration to form the pretreatment solution containing the treated plastic.

### BRIEF DESCRIPTION OF THE DRAWINGS

In order to make the above and other objects, features, advantages and embodiments of the present invention easier to understand, the accompanying drawings are described as follows:

FIG. 1 shows a schematic diagram of the process of preparing a photocatalyst composite according to the embodiments of the present invention.

FIG. 2 shows X-ray diffraction (XRD) patterns of photocatalysts and a photocatalyst composite according to an embodiment of the present invention.

FIG. 3 shows a transmission electron microscope (TEM) image of a photocatalyst composite according to an embodiment of the present invention.

FIG. 4 shows a high-resolution TEM (HR-TEM) image of a photocatalyst composite according to an embodiment of the present invention.

FIG. 5 shows Fourier-transform infrared spectroscopy (FTIR) spectra of photocatalysts and a photocatalyst composite according to an embodiment of the present invention.

FIG. 6 shows X-ray photoelectron spectroscopy (XPS) spectra of photocatalysts and a photocatalyst composite according to an embodiment of the present invention.

FIG. 7 shows the photoluminescence (PL) spectra of a photocatalyst and a photocatalyst composite according to an embodiment of the present invention.

FIG. 8 illustrates the hydrogen production performance of photoreforming plastics of photocatalysts and a photocatalyst composite according to an embodiment of the present invention.

FIG. 9 illustrates hydrogen production conditions of photoreforming plastic of a photocatalyst composite according to an embodiment of the present invention.

FIG. 10 illustrates the hydrogen production effects of a photocatalyst composite in seawater according to an embodiment of the present invention.

According to usual working methods, various features and components in the figures are not drawn to the actual scale. The drawing method is to present specific features and components related to the present invention in the best way. In addition, the same or similar reference symbols are used in different drawings to refer to similar elements and components.

### DETAILED DESCRIPTION OF THE EMBODIMENTS

The following disclosure provides different embodiments or examples to achieve different features of the provided subject matters. The specific examples of components and arrangements described below are for simplifying the present disclosure and are not intended to be limiting; the size and shape of the components are not limited by the disclosed range or numerical values but may depend on the process conditions of the components or the required characteristics. For example, cross-sectional views are used to describe the technical features of the present invention, and these cross-sectional views are schematic diagrams of idealized embodiments. Therefore, variations in the shapes shown in the figures due to manufacturing processes and/or tolerances are to be expected and should not be limited thereby.

Furthermore, spatially relative terms, such as “below”, “beneath”, “lower”, “over” and “higher”, etc., are used to easily describe the relationship between elements or features depicted in the diagrams; in addition, spatially relative terms include not only orientations depicted in diagrams but also different orientations in which the components are used or operated.

First, the content of the embodiments of the present invention relates to a photocatalyst composite and a method of preparing the same, a method of photocatalytic hydrogen production, and a method of photoreforming plastics for hydrogen production. For example, using hydrolyzed plastic (e.g., plastic waste) as a raw material with the help of a suitable photocatalyst, hydrogen is produced under sunlight irradiation, and the hydrolyzed plastic is degraded into economically valuable chemicals. In addition, the photocatalyst composite of the embodiments of the present invention is composed of non-toxic and earth-abundant elements, such as a heterostructure photocatalyst g-C₃N₄/CuFeO₂, which can be prepared by a simple and low-cost method. In short, an embodiment of the present invention is to synthesize the heterostructure photocatalyst g-C₃N₄/CuFeO₂ (i.e., the photocatalyst composite) from the separately prepared g-C₃N₄ and CuFeO₂, and hydrogen is efficiently produced by photoreforming plastic waste. Furthermore, in an embodiment of the present invention, plastic waste (e.g., polyester plastics) is first formed into a hydrolyzed plastic solution in an alkaline solution, and then the heterostructure photocatalyst g-C₃N₄/CuFeO₂ (i.e., the photocatalyst composite) is used as the photocatalyst for photocatalytic hydrogen production and photoreforming plastics for hydrogen production.

Below, the technical content of the embodiments of the present invention will be further described in detail with reference to the relevant drawings.

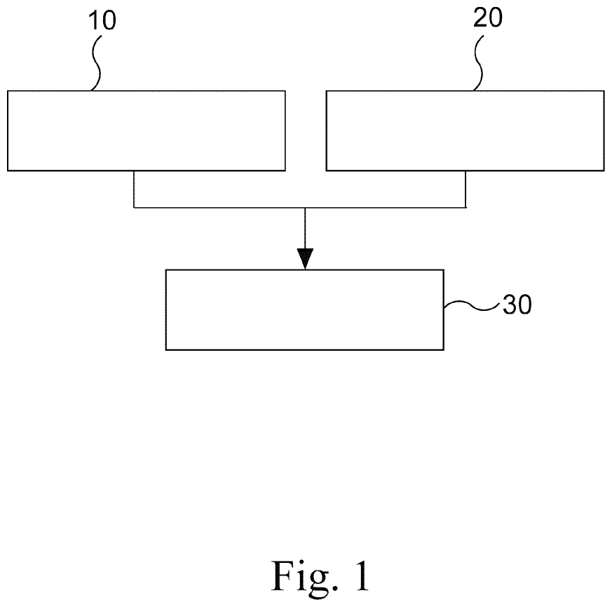

First, please refer to FIG. 1, which is a schematic diagram of the process of preparing a photocatalyst composite according to the embodiments of the present invention. As shown in FIG. 1, a procedure of preparing the photocatalyst includes (1) a step (10) of preparing g-C₃N₄, (2) a step (20) of preparing CuFeO₂, and (3) a step (30) of synthesizing g-C₃N₄/CuFeO₂.

In the step (10) of preparing g-C₃N₄, 2 g of melamine is placed in an Al₂O₃ crucible, followed by being covered with a crucible lid and then heated at a rate of 2° C./min to 550° C. and maintained for 4 hours.

In the step (20) of preparing CuFeO₂, CuFeO₂ is synthesized by a hydrothermal method. Specifically, 7.5 mmol of CuSO₄·5H₂O, 7.5 mmol of FeSO₄·7H₂O and 110 mmol of NaOH are dissolved in 35 ml of H₂O to prepare a precursor solution, where the precursor solution is brown. Afterwards, 16 ml of the brown precursor solution is moved to a 23 ml autoclave and kept at 160° C. for 6 hours. Next, a resulting black powder is collected by centrifugation and washed repeatedly with a mixed solution of ethanol and water. Finally, the black powder is dispersed in water and dried at 60° C. to obtain CuFeO₂.

In the step (30) of synthesizing g-C₃N₄/CuFeO₂, in order to prepare the heterostructure, g-C₃N₄ and CuFeO₂ are dispersed in an ethanol-water mixed solution with a volume ratio of 1:1 followed by sonicating for 30 minutes. The mixed solution is then continuously stirred at 80° C. until the solvent completely evaporates, and a mixed powder is obtained. Afterwards, the mixed powder is ground or heated at 300° C. for 2 hours in a tube furnace under N₂ atmosphere. Next, the mixed powder is washed with water and then collected by centrifugation, followed by drying in a vacuum oven at 60° C. to obtain a photocatalyst composite composed of g-C₃N₄/CuFeO₂. In an embodiment of the present invention, a weight ratio of g-C₃N₄ and CuFeO₂ used to synthesize g-C₃N₄/CuFeO₂ is 5:1.

In addition, in other embodiments of the present invention, a method of preparing a photocatalyst composite also includes (1) a step (10) of preparing g-C₃N₄, (2) a step (20) of preparing CuFeO₂, and (3) a step (30) of synthesizing g-C₃N₄/CuFeO₂. However, in the step of preparing g-C₃N₄ in other embodiments of the present invention, another weight of melamine is placed in an Al₂O₃ crucible, followed by being covered with a crucible lid and then heated at another heating rate for another length of time to obtain g-C₃N₄ powder. In the step of preparing CuFeO₂ in other embodiments of the present invention, CuFeO₂ powder is obtained by synthesizing through a hydrothermal method or another method followed by drying. In the step of synthesizing g-C₃N₄/CuFeO₂ in other embodiments of the present invention, the g-C₃N₄ powder and the CuFeO₂ powder obtained in the previous steps are mixed in another ratio to obtain a photocatalyst composite of g-C₃N₄/CuFeO₂, in which the photocatalyst composite has a heterogeneous structure.

In other embodiments of the present invention, in the step of preparing CuFeO₂, another amount of CuSO₄·5H₂O, another amount of FeSO₄·7H₂O and another amount of NaOH are dissolved in another amount of H₂O to prepare a precursor solution, and another amount of the precursor solution is placed into an autoclave and kept at a different temperature for a different length of time, and a black powder is obtained through centrifugation. After repeated washing with a mixed solution of ethanol and water, the black powder is dispersed in water and dried at another temperature to obtain CuFeO₂ powder.

In other embodiments of the present invention, in the step of synthesizing g-C₃N₄/CuFeO₂, the g-C₃N₄ powder and the CuFeO₂ powder obtained in the aforementioned steps may be mixed in another weight ratio to obtain a photocatalyst composite.

In other embodiments of the present invention, in the step of synthesizing g-C₃N₄/CuFeO₂, in addition to mixing the g-C₃N₄ powder and the CuFeO₂ powder obtained in the previous steps in another weight ratio, it can also be ultrasonic treated for another length of time and then heated at another temperature not exceeding 300° C. for another length of time in a tube furnace under N₂ atmosphere to obtain a photocatalyst composite.

From the above, it can be seen that the process of preparing the photocatalyst of the embodiments of the present invention is relatively simple compared with the prior art and does not require expensive equipment.

In addition, it should be noted that through the process of preparing the photocatalyst of the embodiment of the present invention, the photocatalyst composite can be obtained, and a material of the photocatalyst composite is g-C₃N₄/CuFeO₂, which has a heterogeneous structure and does not exist additional crystalline impurities. Furthermore, in the embodiment of the present invention, g-C₃N₄ and CuFeO₂ used to form the photocatalyst composite are both powders, and a weight ratio thereof is 5:1; in other embodiments, the photocatalyst composite with a weight ratio of g-C₃N₄ and CuFeO₂ of 1:1, 3:1 or 7:1 is also better than pure g-C₃N₄ and CuFeO₂. It should be noted here that the photocatalyst composite of the embodiments of the present invention is a photocatalyst that contains neither precious metals nor toxic metals, has good hydrogen production activity in photoreforming plastics to generate hydrogen, and can oxidize the hydrolyzed plastics into other valuable chemicals through the photogenerated holes.

A process of photoreforming plastics to generate hydrogen according to the embodiment of the present invention is explained below.

A method of producing hydrogen in an embodiment of the present invention includes adding plastic to an alkaline solution to form a pretreatment solution and generating hydrogen by performing a photoreforming reaction in the pretreatment solution using the aforementioned photocatalyst composite.

In an embodiment of the present invention, in the step of forming the pretreatment solution, the plastic is added to a KOH solution with a molar concentration of 10M. After stirring at 80° C. for a predetermined time, the KOH solution is filtered to remove impurities. A predetermined amount of water is then added to the filtered plastic solution for dilution to form the pretreatment solution containing the treated plastic. In other embodiments, the pretreatment solution can be formed by directly placing the plastic into 5M of KOH solution at room temperature, and the solution is directly used as a solution for the photoreforming reaction for hydrogen production.

In other embodiments of the present invention, in the step of forming the pretreatment solution, the plastic is added to the KOH solution with a molar concentration of 10M or another alkaline aqueous solution, and a water source may be water, tap water or seawater. After stirring at 80° C. or another temperature for another length of time, the solution is filtered to remove impurities, and another amount of water, tap water or seawater is added to the filtered plastic solution for dilution to form a pretreatment solution containing the treated plastic.

As can be seen from the above, the photocatalyst composite of the embodiments of the present invention is, for example, a photocatalyst composite composed of g-C₃N₄ (photocatalyst I)/CuFeO₂ (photocatalyst II). The photocatalyst composite (g-C₃N₄/CuFeO₂) exhibits good hydrogen production activity in an alkaline aqueous solution containing a variety of polyester plastics and monomers, which is much higher than the activity of using g-C₃N₄ (photocatalyst I) or CuFeO₂ (photocatalyst II) alone as a catalyst.

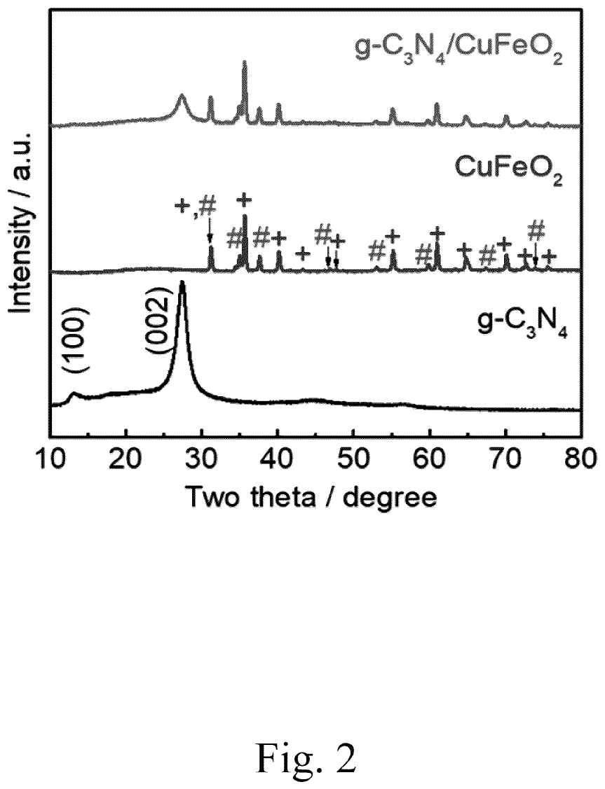

Next, please refer to FIG. 2. FIG. 2 is XRD patterns of photocatalysts and a photocatalyst composite according to an embodiment of the present invention. The XRD results of the photocatalyst composite (g-C₃N₄/CuFeO₂) of an embodiment of the present invention show that all diffraction peaks are composed of the two sets of diffraction peaks of g-C₃N₄ and CuFeO₂, and there are no additional crystalline impurities.

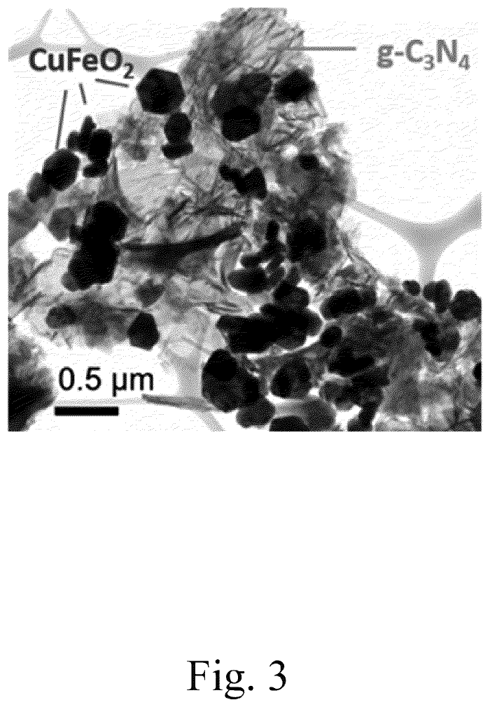

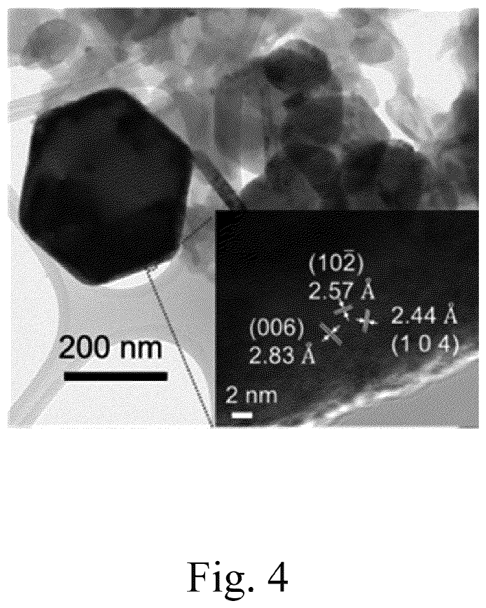

In addition, as shown in FIGS. 3 and 4, FIG. 3 is a TEM image of a photocatalyst composite according to an embodiment of the present invention. FIG. 4 is an HR-TEM image of a photocatalyst composite according to an embodiment of the present invention. FIGS. 3 and 4 show the microstructure and morphology of g-C₃N₄/CuFeO₂, and g-C₃N₄ presents a stacked wrinkled layered structure. The two materials are intertwined to form a heterostructure, which provides more photocatalytic reaction sites to enhance photocatalytic performance.

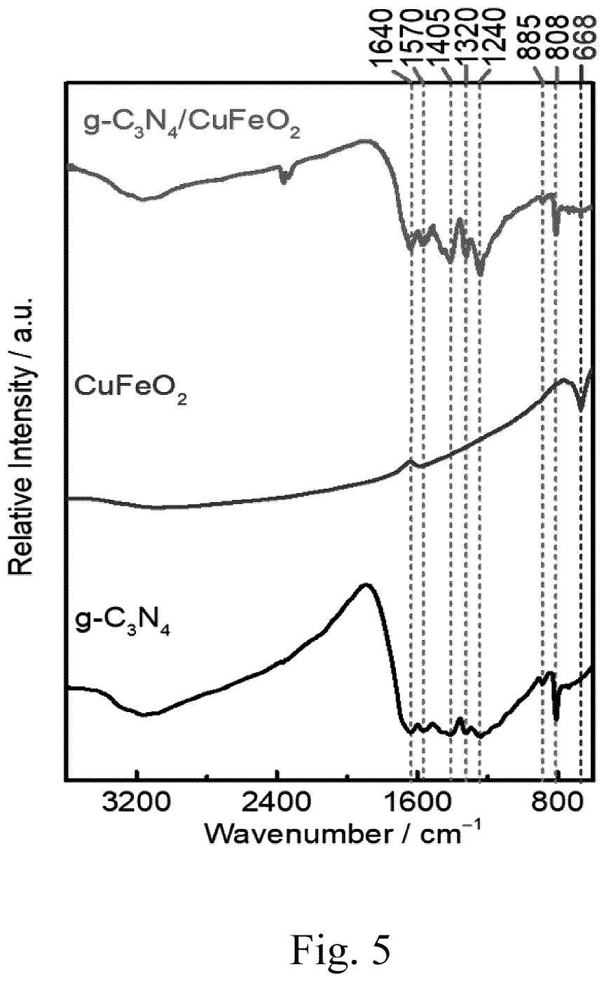

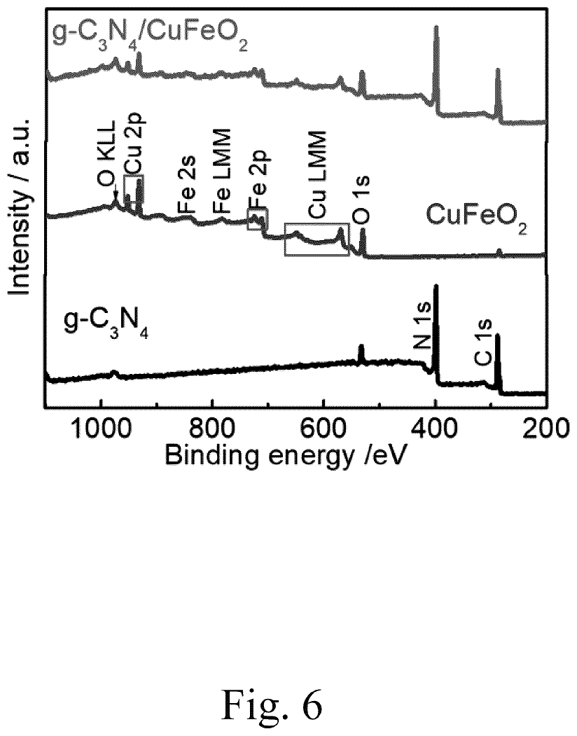

In addition, as shown in FIGS. 5 and 6, FIG. 5 shows FTIR spectra of the photocatalysts and the photocatalyst composite according to an embodiment of the present invention. FIG. 6 is the XPS spectra of the photocatalysts and the photocatalyst composite according to an embodiment of the present invention. The FTIR and XPS results in FIGS. 5 and 6 show that the surface composition and chemical state prove that the g-C₃N₄/CuFeO₂ composite material (i.e., the photocatalyst composite) has been successfully prepared in the embodiment of the present invention.

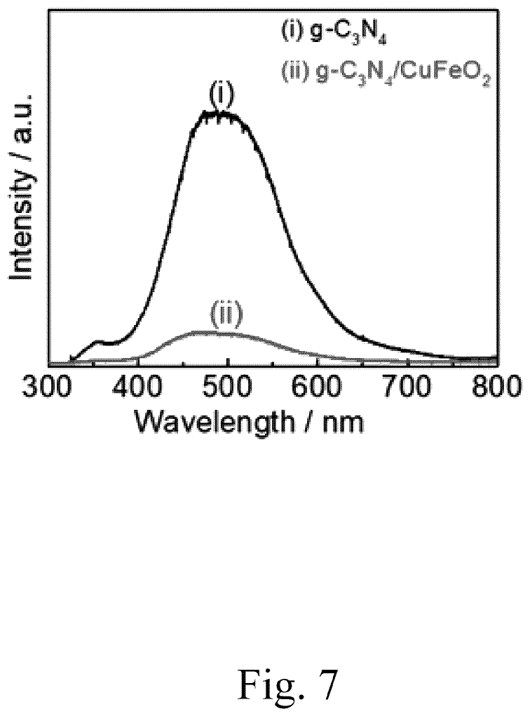

In addition, as shown in FIG. 7, FIG. 7 illustrates the PL spectra of photocatalyst I and the photocatalyst composite according to an embodiment of the present invention. The PL results in FIG. 7 show that the g-C₃N₄/CuFeO₂ heterojunction successfully suppressed the recombination of photogenerated electron-hole pairs.

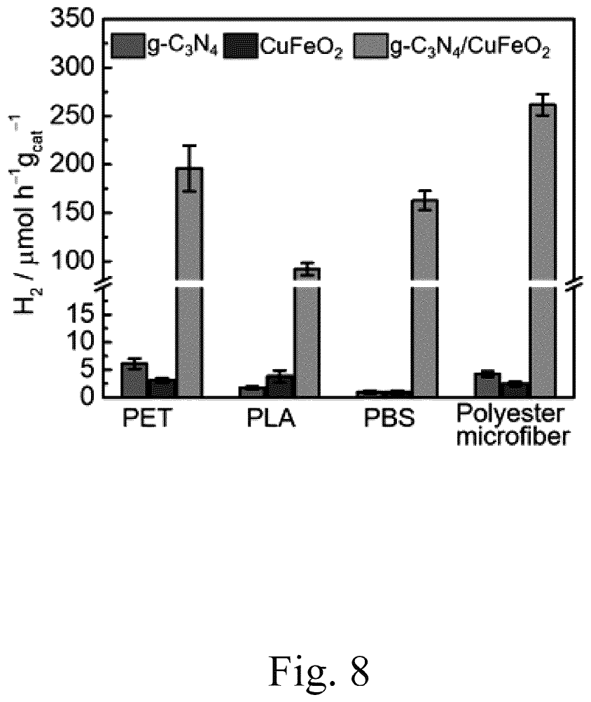

In addition, as shown in FIG. 8, FIG. 8 illustrates the hydrogen production performance of photocatalyst I, photocatalyst II and the photocatalyst composite according to an embodiment of the present invention. The results in FIG. 8 show that g-C₃N₄/CuFeO₂ has excellent photocatalytic hydrogen production activity for photoreforming different types of plastics than that of g-C₃N₄ and CuFeO₂ alone. For photoreforming polyester fibers, the photocatalytic hydrogen production activity of g-C₃N₄/CuFeO₂ is increased by more than 60 times and 100 times than g-C₃N₄ and CuFeO₂, respectively. In addition, although not shown in the figures, for common plastic monomers such as ethylene glycol (EG), lactic acid (LA) or 1,4-butanediol (BTO), the photocatalyst composite (g-C₃N₄/CuFeO₂) of an embodiment of the present invention also has hydrogen production activities much higher than that of g-C₃N₄ and CuFeO₂ alone. In addition, although not shown in the figures, proton nuclear magnetic resonance results show that an oxidation product of the photocatalyst composite of an embodiment of the present invention exhibits a formate signal.

In addition, although not shown in the figures, when discussing simplifying the process of preparing the catalyst, after preparing respective g-C₃N₄ and CuFeO₂, an artificial physical grinding method is used to prepare the photocatalyst composite. The results show that even though the activity of the product after grinding is lower than that of g-C₃N₄/CuFeO₂ prepared by the standard process, the photocatalyst composite of an embodiment of the present invention is still much higher than the respective activity of g-C₃N₄ and CuFeO₂.

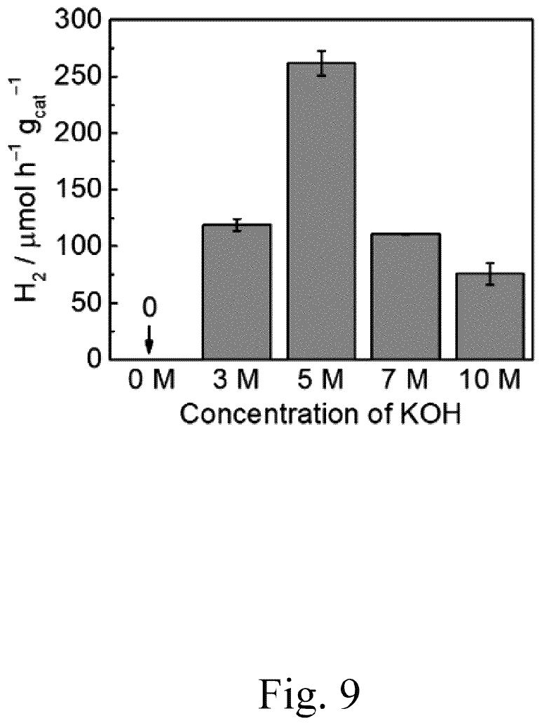

In addition, as shown in FIG. 9, FIG. 9 illustrates hydrogen production conditions of photoreforming plastics using the photocatalyst composite according to an embodiment of the present invention. FIG. 9 shows the performance of the photocatalyst composite (g-C₃N₄/CuFeO₂) in an embodiment of the present invention in different concentrations of KOH aqueous solutions. The results show that g-C₃N₄/CuFeO₂ has good hydrogen production activity in KOH aqueous solutions from 3M to 10M, and it has the best hydrogen production activity when the concentration of KOH is 5M. In addition, although not shown in the figures, the activity of the photocatalyst composite (g-C₃N₄/CuFeO₂) with different ratios is much higher than the respective performances of g-C₃N₄ and CuFeO₂, confirming that the heterostructure of the photocatalyst composite (g-C₃N₄/CuFeO₂) of an embodiment of the present invention inhibits light-induced charge recombination, thereby promoting hydrogen production. In addition, although not shown in the figures, after observing a relationship between activity of the photocatalyst composite (g-C₃N₄/CuFeO₂) in an embodiment of the present invention and the concentrations of a hydrolyzed plastic, it is found that when the concentration of the polyester microfiber is lower than 30 mg mL⁻¹, the activity increases rapidly with the increment of hydrolyzed plastic concentration; however, when the concentration is higher than 40 mg mL⁻¹, the activity of the photocatalyst composite (g-C₃N₄/CuFeO₂) of an embodiment of the present invention reaches saturation.

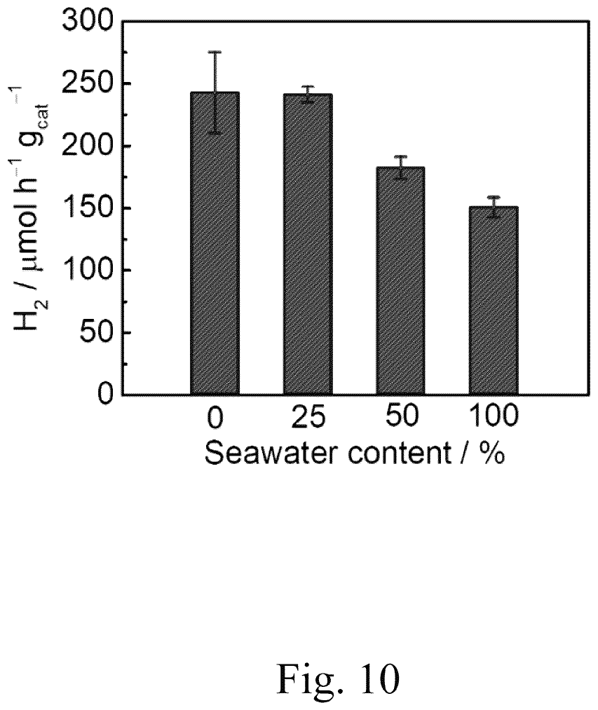

In addition, as shown in FIG. 10, FIG. 10 illustrates the hydrogen production effects of a photocatalyst composite in seawater according to an embodiment of the present invention. The results in FIG. 10 show that when the seawater content exceeded 50%, hydrogen production activity of the photocatalyst composite (g-C₃N₄/CuFeO₂) of an embodiment of the present invention decreases because of high salinity and various impurities in seawater, which might cause side reactions and low stability. It might be that too much Na and Cl-occupied the surface of the photocatalyst, and thus, hydrogen evolution was hindered, or other competing side reactions were induced. However, in 100% of alkaline natural seawater, the photocatalyst composite (g-C₃N₄/CuFeO₂) of an embodiment of the present invention still has hydrogen production activity of 150±8.2 μmol h⁻¹g_{cat}⁻¹. In addition, although not shown in the figures, the photocatalyst composite (g-C₃N₄/CuFeO₂), according to an embodiment of the present invention, could exceed an amount of 3,000 μmol g_{cat}⁻¹ after 48 hours of illumination.

It should be noted again that the present application proposes a low-cost method to prepare the heterostructure photocatalyst g-C₃N₄/CuFeO₂ that does not contain precious metals and toxic elements. For photocatalytic reforming of plastic waste, it exhibits good hydrogen production activity.

In addition, the PL spectra show that the heterojunction of the photocatalyst composite (g-C₃N₄/CuFeO₂) of an embodiment of the present invention successfully suppress the recombination of the photogenerated electron and hole pairs, so it can effectively utilize electrons and holes excited by light for the photocatalytic hydrogen production in reforming plastics.

In addition, for various types of polyester plastics and their monomers, such as polyethylene terephthalate (PET), polylactic acid (PLA), polybutylene succinate (PBS) or polyester microfiber, the photocatalyst composite (g-C₃N₄/CuFeO₂) of an embodiment of the present invention all shows good hydrogen production activity, showing advantages of the photocatalyst in the versatility of plastic reforming.

In addition, in a seawater environment, the photocatalyst composite (g-C₃N₄/CuFeO₂) in an embodiment of the present invention still shows good activity in photoreforming plastics for hydrogen production, showing that the technical strategy of the present application can also solve problems of producing green hydrogen and high-priced organic acids in areas lacking freshwater resources. The photocatalyst composite (g-C₃N₄/CuFeO₂) of an embodiment of the present invention also has good hydrogen production activity in photoreforming plastics in other common water sources, such as tap water and ditch water, which shows advantages of the photocatalytic composite (g-C₃N₄/CuFeO₂) of an embodiment of the present invention in versatility in various water sources.

To sum up, the photocatalyst composite (photocatalyst I/photocatalyst II) provided by the embodiments of the present invention contains neither precious metals nor toxic metals, and still has promising activity in hydrogen production by photoreforming plastics reaction, and can oxidize the hydrolyzed plastics into other valuable chemicals through the photogenerated holes. In addition, photocatalyst I/photocatalyst II provided by the embodiments of the present invention exhibits good hydrogen production activity in alkaline solutions for a variety of polyester plastics and monomers, which is much higher than the activities of using photocatalyst I or photocatalyst II alone as a catalyst. Furthermore, the method of preparing the photocatalyst provided by the embodiments of the present invention is simple and does not require expensive equipment. It should also be noted here that the plastic pretreatment provided by the embodiments of the present invention can reduce the impact of impurities on the light absorption of the photocatalyst.

The above embodiments are only used to illustrate the technical solution of the present invention rather than to limit it. Although the present invention has been described in detail with reference to the preferred embodiments, those skilled in the art will understand that the technical solution of the present invention can be modified or equivalent substitutions may be made without departing from the spirit and scope of the technical solution of the present invention.

What is claimed is:

1. A photocatalyst composite, which is g-C₃N₄/CuFeO₂ and has a heterogeneous structure.

2. The photocatalyst composite of claim 1, wherein g-C₃N₄ and CuFeO₂ used to form the photocatalyst composite are powders, and a weight ratio for constituting the composite is 1:1 to 7:1.

3. A method of preparing a photocatalyst composite, comprising:
a step of preparing g-C₃N₄, heating a predetermined weight of melamine at a predetermined heating rate for a predetermined time to obtain g-C₃N₄ powder;
a step of preparing CuFeO₂, performing a hydrothermal synthesis followed by drying to obtain CuFeO₂ powder; and
a step of synthesizing g-C₃N₄/CuFeO₂, mixing the g-C₃N₄ powder and the CuFeO₂ powder obtained in the previous steps with a predetermined ratio to obtain a photocatalyst composite of g-C₃N₄/CuFeO₂, wherein the photocatalyst composite has a heterogeneous structure.

4. The method of preparing the photocatalyst composite of claim 3, wherein in the step of preparing g-C₃N₄, 2 g of melamine is placed in an Al₂O₃ crucible, followed by being covered with a crucible lid and then heated at a rate of 2° C./min to 550° C. and maintained for 4 hours.

5. The method of preparing the photocatalyst composite of claim 3, wherein in the step of preparing CuFeO₂, a predetermined amount of CuSO₄·5H₂O, a predetermined amount of FeSO₄·7H₂O and a predetermined amount of NaOH are dissolved in a predetermined amount of H₂O to prepare a precursor solution, and a predetermined amount of the precursor solution is then placed into an autoclave and kept at a predetermined temperature for a predetermined time, and a black powder is obtained by centrifugation, followed by repeated washing with a mixed solution of ethanol and water, and the black powder is then dispersed in water and dried at a predetermined temperature to obtain the CuFeO₂ powder.

6. The method of preparing the photocatalyst composite of claim 3, wherein in the step of preparing CuFeO₂, 7.5 mmol of CuSO₄·5H₂O, 7.5 mmol of FeSO₄·7H₂O and 110 mmol of NaOH are dissolved in 35 ml of H₂O to prepare a precursor solution, and 16 ml of the precursor solution is then placed into an autoclave and kept at 160° C. for 6 hours, and the black powder is obtained by centrifugation and followed by repeated washing with a mixed solution of ethanol and water, followed by dispersing the black powder in water and drying at 60° C. to obtain the CuFeO₂ powder.

7. The method of preparing the photocatalyst composite of claim 3, wherein in the step of synthesizing g-C₃N₄/CuFeO₂, the g-C₃N₄ powder and the CuFeO₂ powder obtained in the previous steps are mixed in a weight ratio of 1:1 to 7:1 to obtain the photocatalyst composite.

8. The method of preparing the photocatalyst composite of claim 3, wherein in the step of synthesizing g-C₃N₄/CuFeO₂, the g-C₃N₄ powder and the CuFeO₂ powder obtained in the previous steps are mixed in a weight ratio of 1:1 to 7:1 and dispersed in an ethanol-water mixed solution followed by sonicating and then stirring until the solvent completely evaporates and then heated at no more than 300° C. for 2 hours in a tube furnace under N₂ atmosphere to obtain the photocatalyst composite or the powders are mixed and then physically ground to obtain the photocatalyst composite.

9. A method of producing hydrogen, comprising:
adding plastic to an alkaline solution to form a pretreatment solution and performing a hydrogen production reaction by photoreforming the pretreatment solution using the photocatalyst composite of claim 1.

10. The method of producing hydrogen of claim 9, wherein in the step of forming the pretreatment solution, the plastic is added to a KOH solution with a predetermined volume molar concentration to form the pretreatment solution containing the treated plastic.
